(19) United States
(12) Patent Application Publication
(10) Pub. No.: US 2004/0213939 A1
(43) Pub. Date: Oct. 28, 2004

(54) Electromagnetic wave shielding layer structure and manufacturing method

(75) Inventors: Yueh-Hsiang Hsu, TaoYuan (TW); Chien-Shu Lai, TaoYuan (TW); Ta-Wang Lai, TaoYuan (TW)

Correspondence Address: BRUCE H. TROXELL, SUITE 1404, 5205 LEESBURG PIKE, FALLS CHURCH, VA, 22041, US

(73) Assignee: Optimax Technology Corporation

(21) Appl. No.: 10/624,476

(22) Filed: Jul. 23, 2003

(30) Foreign Application Priority Data
Apr. 25, 2003 (TW) 92110222

(51) Int. Cl. B32B 9/00

(52) U.S. Cl. 428/40.1

(57) ABSTRACT

An electromagnetic wave shielding layer structure is mainly comprised of transparent substrate and mesh, wherein the transparent substrate has first face and second face, and the mesh also has first face and second face, and wherein the second face of mesh is pasted upon the first face of transparent substrate; particularly, the first face of mesh has a pressure sensitive adhesive with an appropriate thickness to replace the ultraviolet (UV) transparency processing adhesive.

### FIELD OF THE INVENTION

The invention relates to an electromagnetic wave shielding layer structure, and in particular, to an electromagnetic wave shielding layer structure that replaces UV transparency processing adhesive with pressure sensitive adhesive.

### BACKGROUND OF THE INVENTION

Plasma TV is mainly comprised of a piece of plasma display panel (abbreviated as PDP), which applies inert gases, that is, plasma (e.g., mixture of Neon gas and Xenon gas) that is sealed between two pieces of glass plates. When electronic discharge is created from outside electric field, the ultraviolet rays converted from the energy, of inert gas, created from electronic discharge will excite fluorescent powders, of red, blue, and green colors, coated upon the glass plates to emit light through front glass and visible by human eyes, so these emitted visible lights construct the colorful pictures viewed by the user.

General speaking, when the user is watching plasma TV, in order to make him feel natural and comfortable in facing the light emitted from plasma TV and to avoid the radiation of electromagnetic wave, a piece of filter is usually arranged in front of plasma display panel disposed in the plasma TV.

Basically, this filter is mainly comprised of electromagnetic wave shielding layer (EMI), color compensating layer, anti-reflecting layer (AR), and glass layer, etc., each of which has its specific function. For example, after the light enters the filter, the metal mesh of electromagnetic wave shielding layer will remove the radiation of electromagnetic wave carried by the light, and the light will also make spectrum calibration for itself by the dye in color compensating layer. As for the glass layer, its main function is to enforce the structure of entire piece of filter. Furthermore, when outside light (ultraviolet ray) is incident upon the filter facing the user, the outside light will be reflected into the user's eyes to make him dizzy, so the anti-reflecting layer is designed to prevent this situation happening. So, when the user is facing the colorful pictures shown by the light that is emitted from the front glass of plasma TV, he will feel natural and comfortable without the threat of electromagnetic wave radiation.

Aiming at this electromagnetic wave shielding layer, the inventor proposes this invention. The prior electromagnetic wave shielding layer is very complicated, and the process for manufacturing the structure of electromagnetic wave shielding layer is divided into two parts of major body and surface layer. Please refer to FIG. 1A, which shows the structure of major body that is the first manufactured part of prior electromagnetic wave shielding layer. Since this major body structure is designed to filter out the electromagnetic wave carried by the light itself by the mesh 110, so the mesh 110 is first pasted upon a transparent glass substrate 120 (usually made of Polyethylene Terephthalate, abbreviated as PET). However, the mesh 110 is a layer structure woven complicatedly so, in considering that, when light passes through the mesh 110, the mesh 110 will greatly reduce the penetrating possibility of light to cause the transmittance of light to be insufficient during passing through this mesh 110. Since the transmittance of frosted glass will be increased after the frosted glass soaks water so, by this principle, the mesh 150 is coated with a layer of UV transparency processing adhesive to expect that the transmittance will be increased when the light passes through the mesh 110. Later on, considering the adhesion ability of UV transparency processing adhesive layer 140 and the protection of UV transparency processing adhesive 140 before its combination with the surface structure of electromagnetic wave shielding layer, a piece of transparent glass substrate 130 is pasted upon the UV transparency processing adhesive 140.

After the major body structure 105 of the electromagnetic wave shielding layer is completed, the manufacturing process of the surface layer structure of electromagnetic wave shielding layer is started next. Except for protecting the major body structure 105, this surface layer structure must also have the characteristic of easy removal, such that it is easy for the major body structure of electromagnetic wave shielding layer to be combined with other layers in the filter. Please refer to FIG. 1B, which shows a simple illustration for the combination between the major body structure and the surface layer structure of the electromagnetic wave shielding layer. After the major body structure 105 is completed, the arrangement of the surface layer structure 145 is that, by pressure sensitive adhesives 150, 160 and in pressure sensitive adhesive manner, the mold-releasing films 170, 180 are respectively pasted upon the outer surfaces 143, 117, of transparent glass substrates 120, 140 in the major body structure 105, corresponding to other layers of pasting faces, such that the major body structure 105 is protected. The match-up between the mold-releasing films 170, 180 and the pressure sensitive adhesives 150, 160 will make it easy to remove the mold-releasing films 170, 180 from the major body structure 105. At last, after the combination of major body structure 105 and surface layer structure 145, a complete electromagnetic wave shielding layer structure 100 is constructed.

The prior electromagnetic wave shielding layer structure and manufacturing manner have following shortcomings:

1. Since there are too many structural layers in the prior electromagnetic wave shielding layer, so the transmittance of light to pass through the prior electromagnetic wave shielding layer is poor.

2. Since there are too many structural layers in the prior electromagnetic wave shielding layer, so the electromagnetic wave shielding layer is too thick and its cost is relatively high.

3. Since the manufacturing process for the prior electromagnetic wave shielding layer is divided into two structure parts to manufacture separately, so its manufacturing efficiency is poor.

4. Since the manufacturing process for the prior electromagnetic wave shielding layer is divided into two structural parts to manufacture separately so, when the electromagnetic wave shielding layer responding to the match-up of other layers in the filter, the improvement of electromagnetic wave shielding layer structure will be involved with the manufacture of its two parts, such that it is uneasy to improve the structure of this electromagnetic wave shielding layer.

Accordingly, the invention proposes an electromagnetic wave shielding layer structure and manufacturing method, which may simplify the number of structural layer, such that its cost may be lowered down and its producing efficiency will be increased.

### SUMMARY OF THE INVENTION

The main objective of the invention is to provide an electromagnetic wave shielding layer structure, which mainly includes transparent substrate and mesh. Wherein, the transparent substrate has first face and second face, and the mesh also has first face and second face. The second face of mesh is pasted with the first face of transparent substrate. Particularly, there is a pressure sensitive adhesive having an appropriate thickness upon the first face of mesh.

In the preferable embodiment according to the invention, for protecting the pressure sensitive adhesive on the surface of mesh from outside damage, a piece of mold-releasing film is disposed upon the surface of pressure sensitive adhesive layer corresponding to the pasting face between the pressure sensitive adhesive layer and the mesh.

For protecting the surface of transparent substrate corresponding to the pasting face between the transparent substrate and the mesh from scratching during transportation, a layer of mold-releasing film is also disposed upon this surface of transparent substrate. To make this surface of transparent substrate be smoothly pasted upon and removed from the mold-releasing film, a layer of pressure sensitive adhesive is disposed between this surface of transparent substrate and the mold-releasing film to press and adhere both together.

The secondary objective of the invention is to provide a manufacturing method for electromagnetic wave shielding layer. This method includes the step to paste mesh upon the surface of transparent substrate and to coat a layer of pressure sensitive adhesive having appropriate thickness upon the mesh's surface corresponding to the pasting face between the mesh and the transparent substrate.

In the preferable embodiment according to the invention, this manufacturing method for electromagnetic wave shielding layer further includes the step to paste a piece of mold-releasing film on the surface of pressure sensitive adhesive layer corresponding to the pasting face between the pressure sensitive adhesive layer and the mesh.

In the preferable embodiment according to the invention, this manufacturing method for electromagnetic wave shielding layer further includes the step to paste another piece of mold-releasing film on the surface of transparent substrate corresponding to the pasting face between the transparent substrate and the mesh.

Additionally, in the preferable embodiment according to the invention, this manufacturing method for electromagnetic wave shielding layer further includes a pasting step for another piece of mold-releasing film and the transparent substrate. The step is that a layer of pressure sensitive adhesive is coated between the pasting face of another piece of mold-releasing film and transparent substrate to smoothly press and paste both together.

In summarizing aforementioned description, the invention proposes an electromagnetic wave shielding layer structure and manufacturing method, wherein a pressure sensitive adhesive having an appropriate thickness is coated upon mesh to replace the prior UV transparency processing adhesive, such that the structure and manufacturing method of an electromagnetic wave shielding layer structure are simplified, the manufacturing cost is lowered down, and the production efficiency is increased.

### BRIEF DESCRIPTION OF THE DRAWINGS

In order to make your esteemed members of reviewing committee further recognize and understand the characteristics, objectives, and functions of the present invention, a detailed description in accordance with corresponding drawings are presented as follows.

FIG. 1A shows the major body structure manufactured first of prior electromagnetic wave shielding layer.

FIG. 1B shows a simple illustration for the combination between the major body structure and the surface layer structure of the electromagnetic wave shielding layer.

FIG. 2 shows a simple illustration for the major body structure of the electromagnetic wave shielding layer of the preferable embodiment according to the invention.

FIG. 3 shows a simple illustration for the complete structure of an electromagnetic wave shielding layer of the preferable embodiment according to the invention.

FIG. 4 shows a table for comparing the structures and optical properties between the electromagnetic wave shielding layer structure according to the preferable embodiment of the invention and the electromagnetic wave shielding layer structure according to prior arts.

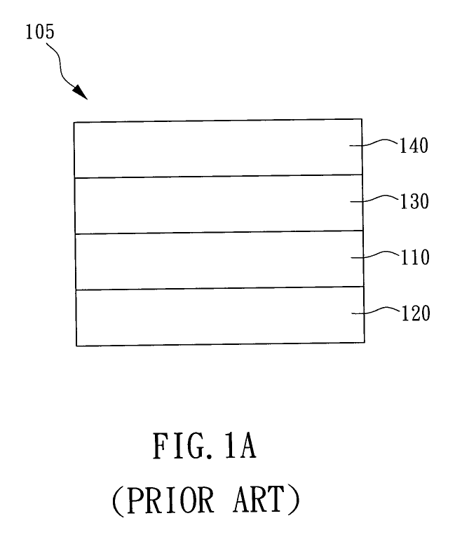

### DETAILED DESCRIPTION OF THE INVENTION

The prior electromagnetic wave shielding layer structure has too many layers and is divided into two parts during manufacturing process, such that the prior electromagnetic wave shielding layer structure has many shortcomings: the thickness is increased, the transmittance is lowered down, the improvement and design are difficult, and the consuming cost is higher, etc. Therefore, the invention applies pressure sensitive adhesive to replace UV transparency processing adhesive, because the pressure sensitive adhesive itself is transparent and has same function as UV transparency processing adhesive, that is, it has the characteristic to increase the transmittance of mesh. If the pressure sensitive adhesive replaces the UV transparency process adhesive, then the structure of electromagnetic wave shielding layer is simplified, the production procedure is relatively simplified, and it is unnecessary to divide the electromagnetic wave shielding layer structure into two parts to manufacture.

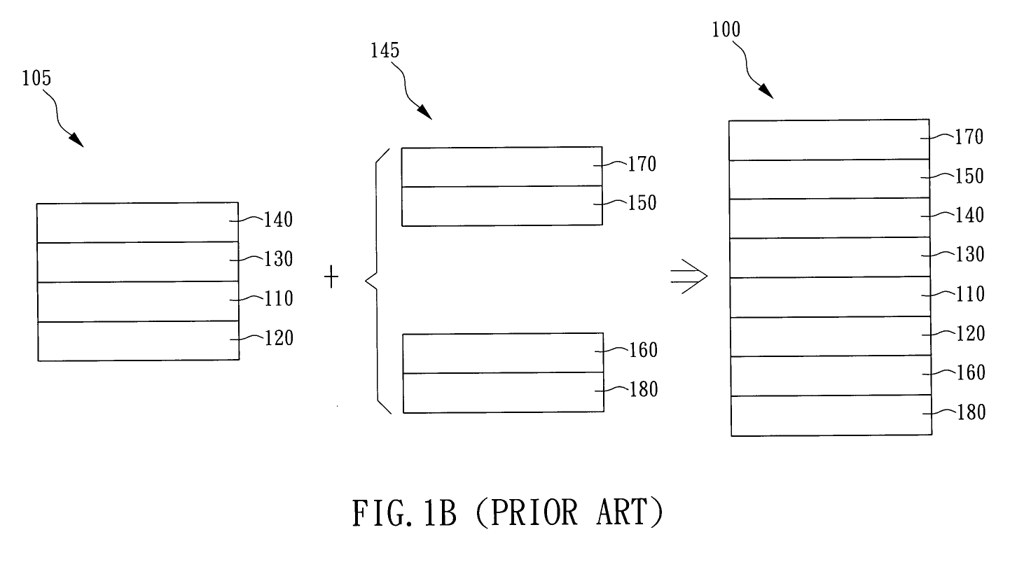

Accordingly, in the electromagnetic wave shielding layer structure of a preferable embodiment according to the present invention, a layer of pressure sensitive adhesive is directly coated upon the surface of mesh corresponding to pasting face between the mesh and the transparent substrate. Please refer to FIG. 2, which shows a simple illustration for the major body structure of the electromagnetic wave shielding layer of the preferable embodiment according to the invention. In this electromagnetic wave shielding layer 200, its major body structure is mainly comprised of: transparent substrate 210 (its made materials may be triacetate or polyethylene terephthalate; abbreviated as TAC or PET), mesh 220 positioned above the surface of transparent substrate 210, and a layer of pressure sensitive adhesive 230 that has X thickness and is coated upon the surface of mesh 220 corresponding to the pasting face between the mesh 220 and the transparent substrate 215.

To prove that the pressure sensitive adhesive 230 coated upon the surface 225 of mesh 220 may really replace the UV transparency processing adhesive applied in prior electromagnetic wave shielding layer structure, the invention makes an optical experiment on the electromagnetic wave shielding layer 200 according to a preferable embodiment of the invention. In the experiment, when the thickness X of the pressure sensitive adhesive 230 reaches a specific value, the pressure sensitive adhesive 230 has the same function as that of UV transparency processing adhesive layer and may increase the transmittance of the mesh.

Therefore, it is expected that the pressure sensitive adhesive 230 coated upon the surface 225 of the mesh 220 may indeed replace the prior UV transparency processing adhesive and may be acted as materials for improving the transmittance of the mesh 220 in the electromagnetic wave shielding layer 200.

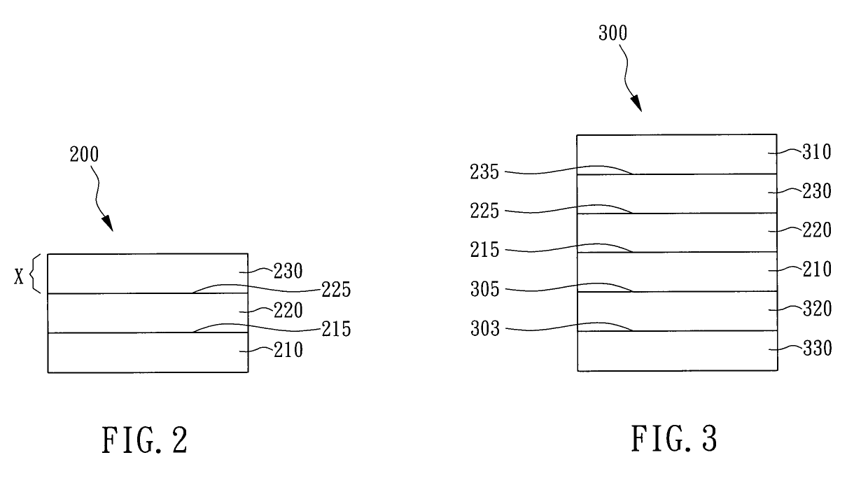

When the major body structure of the electromagnetic wave shielding layer is simplified as shown in FIG. 2, the manufacturing procedure of the surface layer of the electromagnetic wave shielding layer 200 may also be simplified. Please refer to FIG. 3, which shows a simple illustration for the complete structure of an electromagnetic wave shielding layer of the preferable embodiment according to the invention. When the surface 225 of the mesh 220 is coated with pressure sensitive adhesive 230, the electromagnetic wave shielding layer structure may be formed by directly pressing a mold-releasing film 310 upon the surface 235 of the pressure sensitive adhesive 230 corresponding to the surface 225. After coating a layer of pressure sensitive adhesive 320 upon the surface 305 of the transparent substrate 210 corresponding to the pasting face 215, the mold-releasing film 330 is pressed upon. After the mold-releasing films 310, 330 are added to the major body structure 105, a complete electromagnetic wave shielding layer structure 300 is formed.

If the complete electromagnetic wave shielding layer 300 structure according to the preferable embodiment of the invention is compared to the electromagnetic wave shielding layer 100 structure according to the prior arts, it may find that, under the situations of simplified structural layer and manufacturing process, the electromagnetic wave shielding layer 300 according to the preferable embodiment of the invention still has the same optical properties as and the better transmittance than those of the electromagnetic wave shielding layer 100 structure according to prior arts.

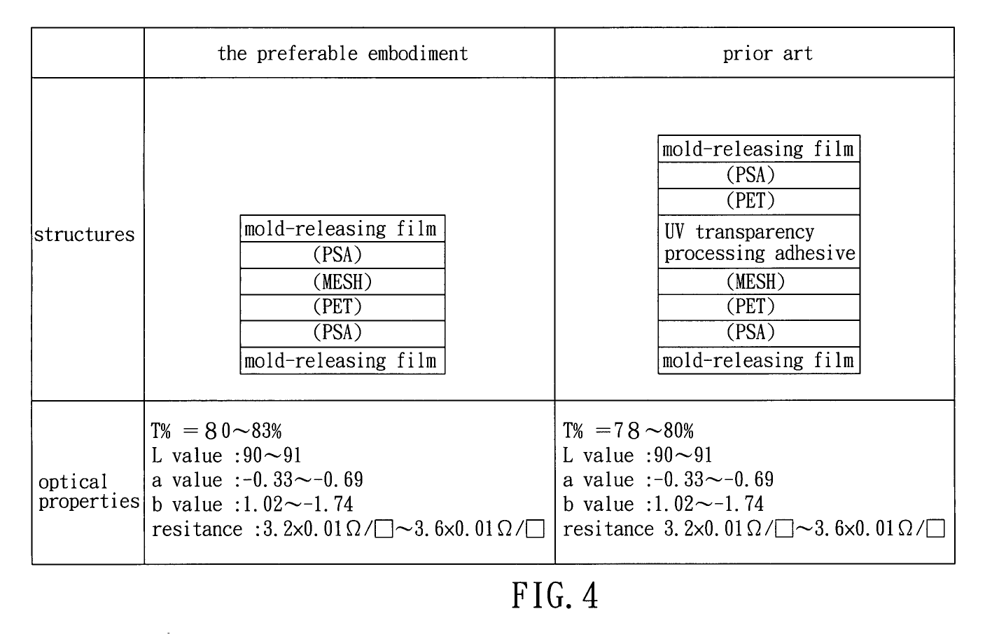

Please refer to FIG. 4, which shows a table for comparing the structures and optical properties between the electromagnetic wave shielding layer structure according to the preferable embodiment of the invention and the electromagnetic wave shielding layer structure according to prior arts. In FIG. 4, after a layer of UV transparency processing adhesive and a layer of transparent substrate according to prior arts are removed, the optical properties of the invention is not worse than those of the prior arts, such as: the L value, a value, b value, and resistance value, etc., which are all same for both cases. As for transmittance (T %), the preferable embodiment according to the invention is better than the prior arts by 2˜3%. Therefore, under the situations of simplified structural layer and manufacturing process, the electromagnetic wave shielding layer 300 according to the preferable embodiment of the invention still has the same optical properties as and the better transmittance than those of the electromagnetic wave shielding layer 100 structure according to prior arts.

The invention has following advantages:

1. Since the invention has removed a layer of UV transparency processing adhesive and a layer of transparent substrate from the prior arts so, not only the thickness of structure itself is thinned (70˜80 micrometers thinner), but also the materials, the manufacturing steps, and the cost of these two layers are saved.

2. The invention applies pressure sensitive adhesive to replace UV transparency processing adhesive, so those familiar with such arts should know that, because of the material characteristic of pressure sensitive adhesive itself, the pressure supporting degree of entire electromagnetic wave shielding layer is promoted.

3. The invention is a layer of structure often used in filter so, when the invention is applied in the eye-protecting glasses of plasma TV, the thickness of plasma TV may be reduced and the cost of plasma TV may also be lowered down.

In summary, the invention proposes an electromagnetic wave shielding layer structure and manufacturing method, which coats pressure sensitive adhesive layer having an appropriate thickness upon the mesh to replace the UV transparency processing adhesive according to prior arts, such that the structure and the manufacturing method of the electromagnetic wave shielding layer is simplified, the manufacturing cost is lowered down, and the production efficiency is increased.

However, aforementioned description is only preferable embodiment according to the present invention and is not any limitation constrained upon the scope of the invention. Any equivalent variation and modification made according to the claims of the invention are still not departed from the merits of the invention, and are also within the spirit and scope of the invention, so they are all regarded as further executable situations of the invention.

What is claimed is:

1. An electromagnetic wave shielding layer structure, which includes:
a transparent substrate, which has first face and second face; and
a mesh, which has first face and second face, and the first face of which is coated with a layer of pressure sensitive adhesive with an appropriate thickness, and the second face of which is pasted with the first face of the transparent substrate.

2. The electromagnetic wave shielding layer structure according to claim 1, wherein the structure further includes:
a mold-releasing film, which has first face and second face, and the second face of which is pasted with the pressure sensitive adhesive layer and is corresponding to the first face of mesh.

3. The electromagnetic wave shielding layer structure according to claim 2, wherein the structure further includes:
another mold-releasing film, which has first face and second face, and the first face of which is pasted with the second face of transparent substrate.

4. The electromagnetic wave shielding layer structure according to claim 3, wherein another layer of pressure sensitive adhesive is included between the second face of transparent substrate and the first face of another mold-releasing film.

5. The electromagnetic wave shielding layer structure according to claim 3, wherein the transparent substrate is a layer of polyethylene terephthalate (abbreviated as PET).

6. The electromagnetic wave shielding layer structure according to claim 3, wherein the transparent substrate is a layer of triacetate (abbreviated as TAC).

7. A manufacturing method for electromagnetic wave shielding layer, the method comprising:
pasting a mesh upon the surface of a transparent substrate; and
coating a pressure sensitive adhesive layer having an appropriate thickness upon the surface of mesh corresponding to the pasting face between the mesh and the transparent substrate.

8. The electromagnetic wave shielding layer according to claim 7, wherein the method further includes:
pasting a mold-releasing film upon the surface of pressure sensitive adhesive layer corresponding to the pasting face between the pressure sensitive adhesive layer and the mesh.

9. The electromagnetic wave shielding layer according to claim 8, wherein the method further includes:
pasting another mold-releasing film upon the surface of transparent substrate corresponding to the pasting face between the transparent substrate and the mesh.

10. The electromagnetic wave shielding layer according to claim 9, wherein the method further includes:
coating another pressure sensitive adhesive layer between the pasting faces of another mold-releasing film and the transparent substrate.

11. An eye-protecting filter used in plasma TV, wherein the electromagnetic wave shielding layer of eye-protecting filter includes:
a transparent substrate, which has first face and second face; and
a mesh, which has first face and second face, and the first face of which is coated with a layer of pressure sensitive adhesive with an appropriate thickness, and the second face of which is pasted with the first face of the transparent substrate.

12. The eye-protecting filter used in plasma TV according to claim 11, wherein the transparent substrate of the electromagnetic wave shielding layer structure is a layer of polyethylene terephthalate (abbreviated as PET).

13. The eye-protecting filter used in plasma TV according to claim 11, wherein the transparent substrate of the electromagnetic wave shielding layer structure is a layer of triacetate (abbreviated as TAC).
